(19) United States
(12) Patent Application Publication
(10) Pub. No.: US 2006/0089897 A1
(43) Pub. Date: Apr. 27, 2006

(54) Systems and methods for online trade-in of goods

(76) Inventors: Eric Maas, Salt Lake City, UT (US); Jalali Hartman, Neptune Beach, FL (US)

Correspondence Address: FENWICK & WEST LLP, SILICON VALLEY CENTER, 801 CALIFORNIA STREET, MOUNTAIN VIEW, CA, 94041, US

(21) Appl. No.: 11/212,515

(22) Filed: Aug. 24, 2005

Related U.S. Application Data
(60) Provisional application No. 60/604,747, filed on Aug. 25, 2004.
(60) Provisional application No. 60/609,036, filed on Sep. 9, 2004.
(60) Provisional application No. 60/646,209, filed on Jan. 21, 2005.

(51) Int. Cl. G06Q 40/00

(52) U.S. Cl. 705/37

(57) ABSTRACT

An online trade-in system comprises: a pricing guide module, an affiliates module, a marketplace listing module, a trade-in website module, a transaction processing module, an inventory handling module, a database and a marketplace manager. The marketplace manager creates an online trade-in system that accesses the other modules to complete a trade-in transaction. The pricing guide module is used to define the items that are acceptable by the merchant for trade-in as well as a price for each item. The marketplace manager uses information from the pricing guide module and provides it to the transaction processing module along with user input to begin and create a trade-in transaction. The marketplace manager uses also controls the inventory handling module to generate a reverse logistic label that can be used by the user to send the trade-in goods back to the merchant, and track the trade-in goods as well as initiate the process to list the item on an online marketplace. The present invention also includes a number of novel methods including: a method for performing an online trade-in, a method for creating a pricing guide, a method for handling inventory, a method for item record creation, a method for dynamic pricing of trade-in goods, and a method for performing trade-ins for affiliates.

### CROSS-REFERENCES TO RELATED APPLICATIONS

The present application claims priority under 35 U.S.C. § 119(e) to: 1) U.S. Provisional Patent Application No. 60/604,747, filed on Aug. 25 2004, entitled “ON-LINE TRADE-IN AND SHIPPING SYSTEM FOR AN ON-LINE MARKETPLACE”; 2) U.S. Provisional Patent Application No. 60/609,036, filed on Sep. 9, 2004, entitled “ON-LINE MARKETPLACE PRODUCT CONFIGURATION TOOL”; 3) U.S. Provisional Patent Application No. 60/646,209, filed on Jan. 21, 2005, entitled “TRADE-IN SYSTEM” which is incorporated by reference in its entirety.

### BACKGROUND OF THE INVENTION

1. Field of the Invention

The present invention relates to systems and methods for executing the sale and purchase of goods in an on-line market place. In particular, the present invention relates to systems and method for on-line trade-in of goods.

2. Description of the Background Art

The use and proliferation of the Internet for purchasing and selling goods and services is well known. With that advent of eBay® and other online auctions or marketplaces, there has been tremendous growth in the number and dollars amount of goods being sold and purchased over the Internet. In such transactions, a seller must create and post a listing including a description of the goods to be sold, a reserve price, and other information. This process can be time consuming and has not been fully automated.

While individual users and some companies have listed used goods for sale on such online marketplaces, it is very difficult in not impossible to provide a trade-in to discount the price of a new item. For example, even in a market segment where trade-in transactions are common such as automobile sales like eBay motors, there is currently no mechanism to get trade-in information and acceptance before a transaction is completed.

Therefore, what is needed is automated systems and method for on-line trade-in of goods.

### SUMMARY OF THE INVENTION

The present invention overcomes the deficiencies and limitations of the prior art by providing an online trade-in system. In one embodiment, the online trade-in system comprises: a pricing guide module, an affiliates module, a marketplace listing module, a trade-in website module, a transaction processing module, an inventory handling module, a database and a marketplace manager. The marketplace manager creates an online trade-in system that accesses the other modules to complete a trade-in transaction. The pricing guide module is used to define the items that are acceptable by the merchant for trade-in as well as a price for each item. The marketplace manager uses information from the pricing guide module and provides it to the transaction processing module along with user input to begin and create a trade-in transaction. The marketplace manager uses also controls the inventory handling module to generate a reverse logistic label that can be used by the user to send the trade-in goods back to the merchant, and track the trade-in goods as well as initiate the process to list the item on an online marketplace. The affiliates module is used to provide affiliates with a trade-in capability using an existing trade-in system. The marketplace listing module is used to provide trade-in calculators in marketplace listings. The trade-in website module is used to create customer facing website that allows traders to browse equipment eligible for trade, as well as shop for normal for-sale merchandise.

The present invention also includes a number of novel methods including: a method for performing an online trade-in, a method for creating a pricing guide, a method for handling inventory, a method for item record creation, a method for dynamic pricing of trade-in goods, and a method for performing trade-ins for affiliates.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a block diagram of a general system including the trade-in system of the present invention.

FIG. 2 is a block diagram of a first embodiment of the trade-in system of the present invention.

FIG. 3 is a block diagram of a second embodiment of the trade-in system of the present invention.

FIG. 4 is a block diagram of a memory of the trade-in system in accordance with the second embodiment of the present invention.

FIG. 5 is a flowchart of an embodiment of a method for trading in goods.

FIG. 6 is a flowchart of an embodiment of a method creating a pricing guide according to the present invention.

FIG. 7 is a flowchart of an embodiment of a method for the trade-in process according to the present invention.

FIG. 8 is a flowchart of an embodiment of a method for processing a traded-in item according to the present invention.

FIG. 9 is a flowchart of an embodiment of a method for creating a master record or stock keeping unit for an item according to the present invention.

FIG. 10 is a flowchart of an embodiment of a method for dynamically pricing an item according to the present invention.

FIG. 11 is a flowchart of an embodiment of a method for trading in goods using an affiliate website according to the present invention.

FIG. 12 is a graphical representation of an exemplary interface for beginning the trade-in process according to one embodiment of the present invention.

FIG. 13 is a graphical representation of the exemplary interface for specifying an item supplemented with data for a specific item and a price provided by the system.

FIG. 14 is a graphical representation of an exemplary interface for specifying additional data information about an item according to one embodiment of the present invention.

FIG. 15 is a graphical representation of an exemplary interface for accepting a trade-in offer from the system according to one embodiment of the present invention.

FIG. 16 is a graphical representation of an exemplary shopping cart interface generated by the trade-in system according to one embodiment of the present invention.

FIG. 17 is a graphical representation of an exemplary interface generated by the trade-in system for providing information to a user about a trade-in amount or value according to one embodiment of the present invention.

FIG. 18 is a graphical representation of an exemplary interface generated by the trade-in system for providing information to a user about a trade-in cash amount according to one embodiment of the present invention.

FIG. 19 is a graphical representation of an exemplary interface generated by the trade-in system for providing master SKUs to a user about trade-in items according to one embodiment of the present invention.

FIG. 20 is a graphical representation of an exemplary interface generated by the trade-in system for providing SKU data to a user about a trade-in item according to one embodiment of the present invention.

### DETAILED DESCRIPTION OF THE PREFERRED EMBODIMENTS

System and methods for trading in items in an on-line market place are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described primarily with reference to a trade-in system for golf clubs. However, the present invention applies to any type of goods or services in an on-line marketplace.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to petform the required method steps. The required structure for a variety of these systems will appear from the description below. In addition, the present invention is not described with reference to any particular programming language. It will be appreciated that a variety of programming languages may be used to implement the teachings of the invention as described herein.

Moreover, the present invention claimed below is operating on or working in conjunction with an information system or network. The present invention is capable of operating with any information system from those with minimal functionality to those providing all the functionality disclosed herein.

Overview

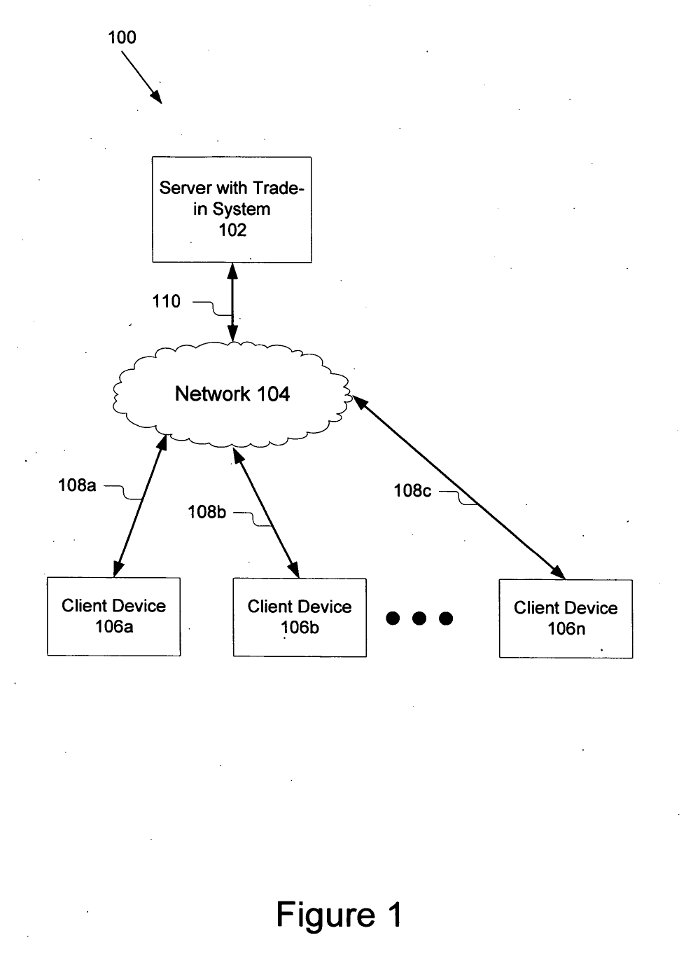

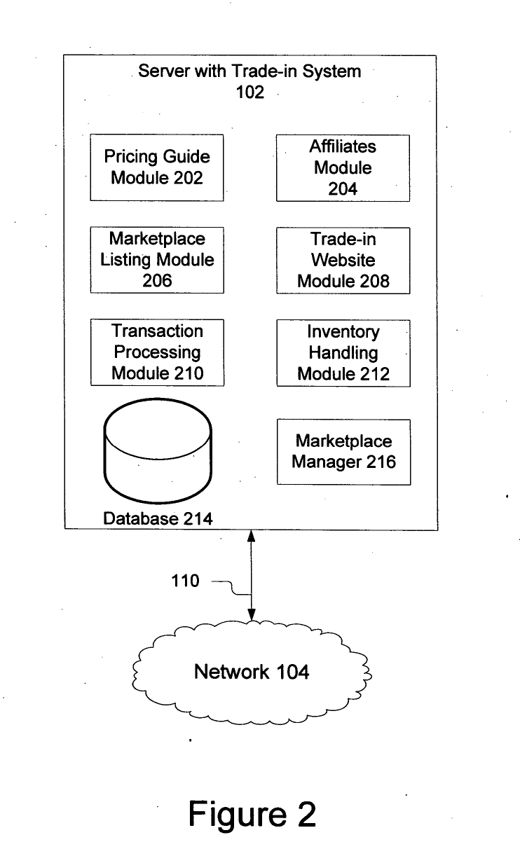

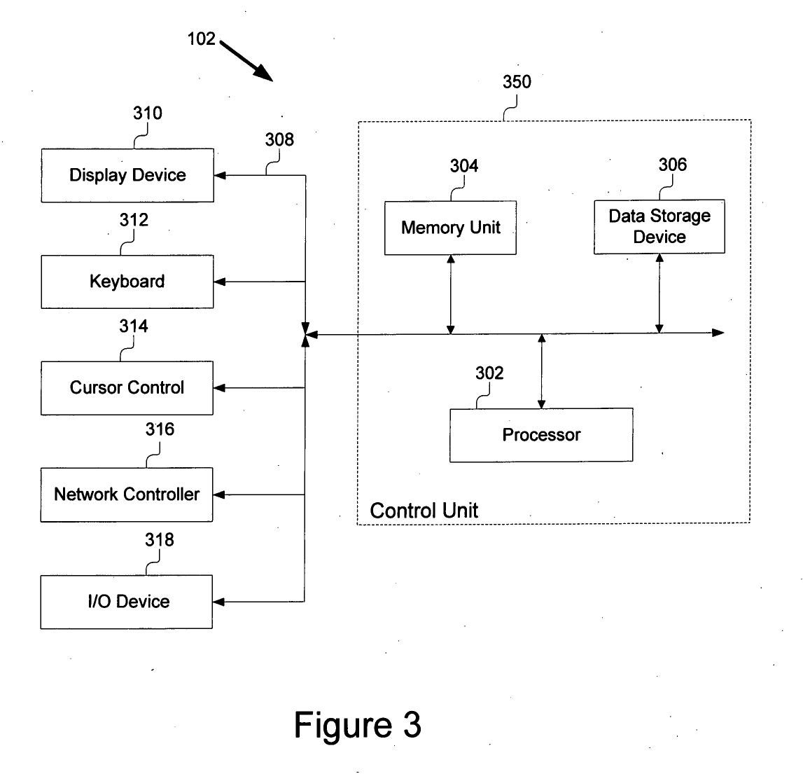

Referring now to FIG. 1, a first embodiment of a system 100 such as an online market place and including a trade-in system of the present invention is shown. In this first embodiment, the system 100 comprises: a server including the trade-in system 102, a network 104, and a plurality of a client devices 106a-n. The server 102 is a conventional type of web server, but also includes the trade-in system of the present invention as will be described in detail below with reference to FIGS. 2 and 3. The server 102 is coupled by a signal line 110 to the network 104. The network 104 is a conventional type such as the Internet, a local area network (LAN), a wide area network (WAN). The network 104 couples the server 102 to client devices 106a-n for communication and to consummate transactions between the client devices 106a-n and the trade-in system 102. The network 104 is coupled to the plurality of client devices 106a-n by respective signal lines 108a-n. The client devices 106a-n can be personal computers, personal digital assistants, thin-client interface terminals or other devices that enable communication to the server 102.

The system 100 advantageously allows users to buy and sell goods in online market places or as direct transactions from online sellers to buyers. The present invention enhances the existing marketplaces and online transactions by providing an easy and automatic way for sellers to accept and buyers to submit used goods or articles for trade-in. Those skilled in the art will recognize that the trade-in system 102 of the present invention can be used alone without an online marketplace or transaction, but will be disclosed below in the context of on-line marketplace. The system 102 of the present invention is particularly advantageous because it facilitates the sourcing and buying of used merchandise (trade-in items) from end users (tradees) for merchants. The trade-in items are used as a form of currency for the tradee towards the purchase of new items from the merchant. The trade-in items are shipped to the merchant using shipping labels automatically created by system 102. The new purchases are shipped back to the tradee by the merchant. A new stock keeping unit (SKU) (trade SKU) is automatically created by the system 102 for inventory management. The merchant then uses the system 102 to find a buyer for the trade item at a marked up price on marketplaces, referral sites and using website traffic.

System

Referring now to FIG. 2, a block diagram of a first embodiment of the trade-in system 102 of the present invention is shown. The first embodiment of the trade-in system 102 is preferably a server including: a pricing guide module 202, an affiliates module 204, a marketplace listing module 206, a trade-in website module 208, a transaction processing module 210, an inventory handling module 212, a database 214 and a marketplace manager 216.

The marketplace manager 216 is an application program that controls and is coupled to the other modules 202, 204, 206, 208, 210 and 212 of the system 102. The marketplace manager is the application that the merchant uses to facilitate and manage the selling of his/her items, both new items as well as trade items. The marketplace manager 216 also manages the trade-in process.

In preparation for receiving trade-ins, the pricing guide module 202 creates an inventory of “tradable” items. This comprises, at its most basic level, a SKU#, a description, and base trade-in price (price paid for item) for each tradable item. If there are specific attributes (such as condition, size, shaft type) that effect the value of the item, these items can be set up for dynamic pricing based on a series of price adjustment files also uploaded to the system 102. Additionally, pricing information can be sourced dynamically for any number of 3^{rd} party sources as will be described in more detail below. All of this product pricing information is stored in the database 214 and is accessible by the marketplace manager 216.

The affiliates module 204 is used to redirect potential users from the websites of affiliates and OEMs to the trade-in system 102. The affiliates module 204 helps create trade-in interfaces that the have the same or similar look and feel of the affiliate site. All trade-in transactions appear to be completed at the affiliate, but are actually being redirected to trade-in system 102. On the back-end, affiliate orders are filtered within the marketplace manager 216, and shipping labels generated reflect the affiliate specifics.

The marketplace listing module 206 is used to provide trade-in calculators in marketplace listings such as eBay®. By combining the client-created price guide information, with flash programming, the marketplace listing module 206 generates trade-in calculators in marketplace listings. Price guide information is made available in real-time to customers browsing items for sale by the same vendor (or affiliates) by communication between the marketplace listing module 206 and the pricing guide module 202. The addition of a trade-in calculator has shown to be effective not only as an inventory acquisition tool, but also for marketing items that are for sale.

The trade-in website module 208 is used to create customer facing website that allows traders to browse equipment eligible for trade, as well as shop for normal for-sale merchandise. Within the trade-in area, the customer completes a trade-in (or combined trade/sale) transaction as specified below. This is a usually a custom designed website, but may also be a standard, template-driven site.

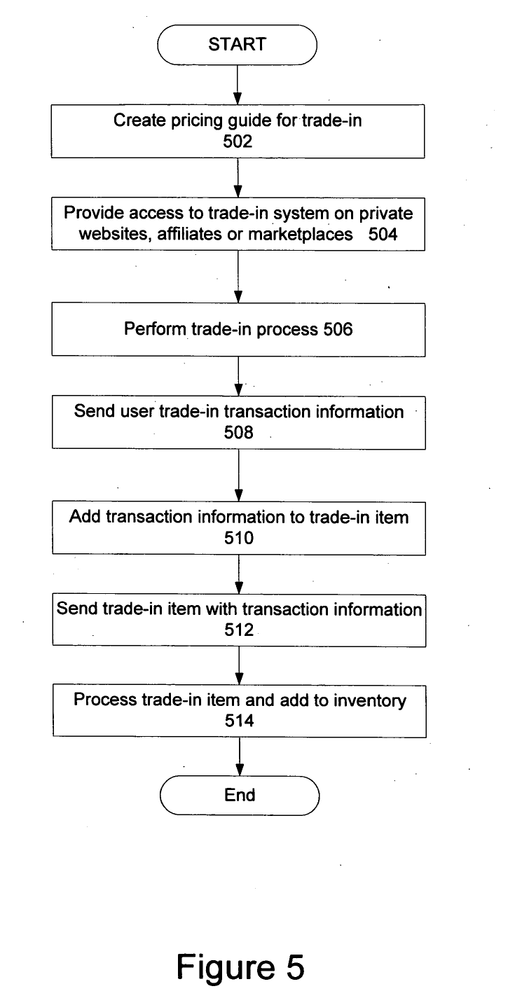

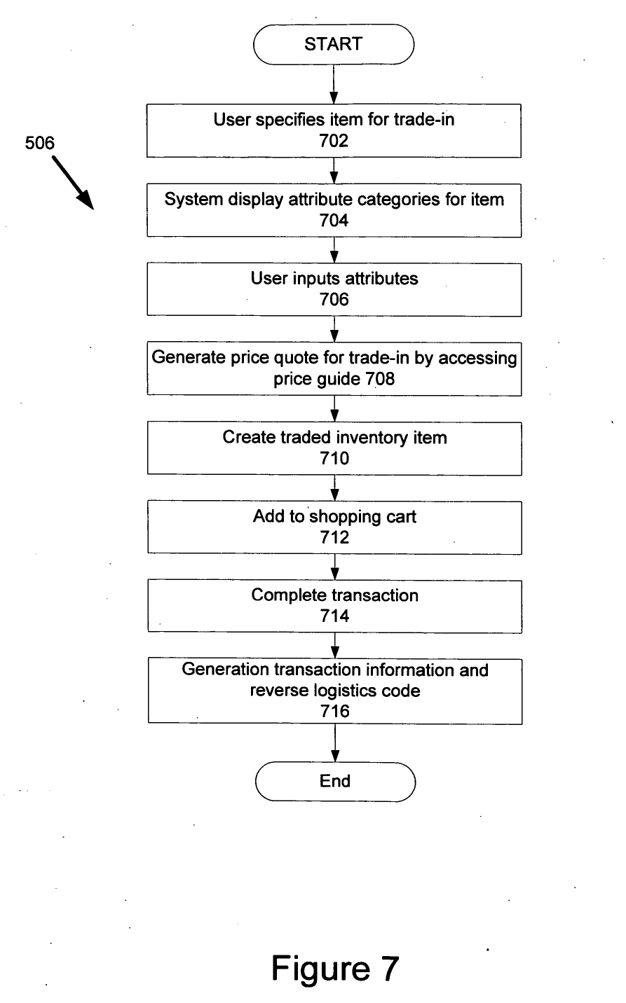

The transaction processing module 210 accepts input from the user and creates the interfaces to specify goods for trade-in, present pricing, create inventory records and processes other information required to complete the transaction. For example, a trader navigates to the base product they are interested in trading (e.g., Callaway Driver) and identifies the specifics of their club (e.g., loft, shaft type, condition). They are presented with both cash and a credit offered that is calculated based on the specifics they provided. This item is added to the cart as a trade and the trader can “checkout” to receive a reverse logistics label, provided by the trade-in system 102. When an offer is accepted, a clone of the base SKU is automatically generated and includes all of the item specifics provided by the trader. This process is described in detail below with reference to FIGS. 5 and 7.

The inventory handling module 212 is responsible for additional processing once an item is scanned and indicated to have been received. Once the item is received it is scanned, verified, and activated for sale by the inventory handling module 212. The inventory handling module 212 also signals the marketplace manager 216 to create a payment (check or credit) to the user and records it as part of the invoice. The received item is automatically listed for sale in either the client's website or appropriate marketplaces by the inventory handling module 212.

The database 214 is a conventional type and is used to store data about specific goods, pricing, transaction and other information as will be understood to those skilled in the art. While the database 214 is shown for convenience and ease of understanding as part of the server 102, it should be recognized that the database could be a separate stand-alone system such as those provided by SAP, Oracle or other database companies and which communicates with server 102.

Referring now to FIG. 3, a block diagram of a second embodiment of the trade-in system 102 of the present invention is shown. The trade-in system 102 preferably comprises a control unit 350, a display device 310, a keyboard 312, a cursor control device 314, a network controller 316 and one or more input/output (I/O) device(s) 318.

Control unit 350 may comprise an arithmetic logic unit, a microprocessor, a general purpose computer, a personal digital assistant or some other information appliance equipped to provide electronic display signals to display device 310. In one embodiment, control unit 350 comprises a general purpose computer having a graphical user interface, which may be generated by, for example, a program written in Java running on top of an operating system like WINDOWS®V or UNIX®I based operating systems. In one embodiment, one or more application programs are executed by control unit 350 including, without limitation, word processing applications, electronic mail applications, financial applications, and web browser applications.

Still referring to FIG. 3, the control unit 350 is shown including processor 302, memory unit 304, and data storage device 306, all of which are communicatively coupled to system bus 308.

Processor 302 processes data signals and may comprise various computing architectures including a complex instruction set computer (CISC) architecture, a reduced instruction set computer (RISC) architecture, or an architecture implementing a combination of instruction sets. Although only a single processor is shown in FIG. 3, multiple processors may be included.

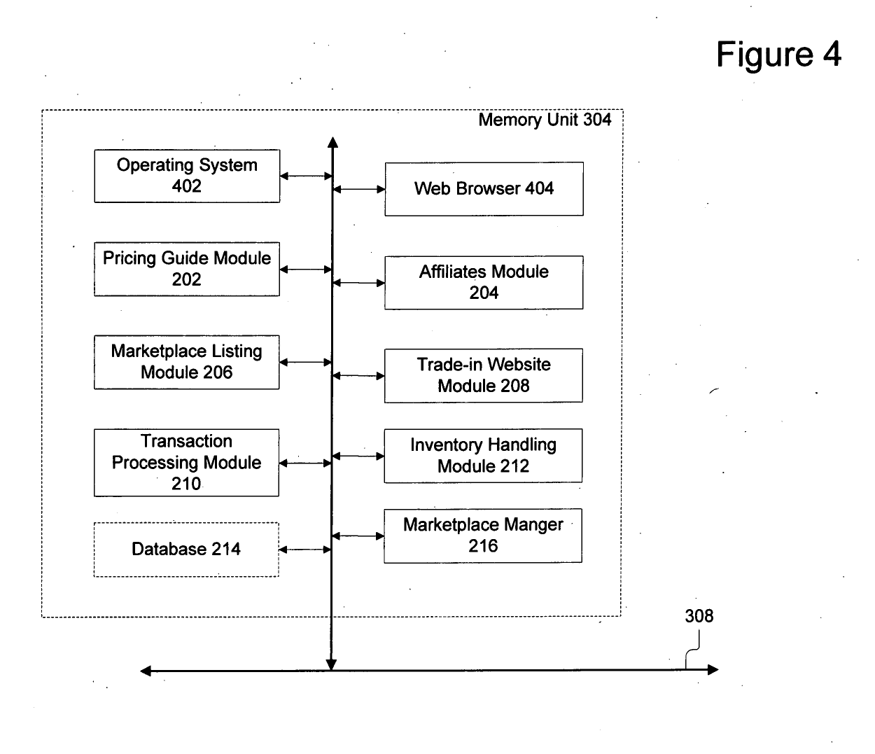

Memory unit 304 stores instructions and/or data that may be executed by processor 302. The instructions and/or data may comprise code for performing any and/or all of the techniques described herein. Memory unit 304 may be a dynamic random access memory (DRAM) device, a static random access memory (SRAM) device, or some other memory device known in the art. The memory 304 is described in more detail below with reference to FIG. 4.

Data storage device 306 stores data and instructions for processor 302 and comprises one or more devices including a hard disk drive, a floppy disk drive, a CD-ROM device, a DVD-ROM device, a DVD-RAM device, a DVD-RW device, a flash memory device, or some other mass storage device known in the art.

System bus 308 represents a shared bus for communicating information and data throughout control unit 350. System bus 308 may represent one or more buses including an industry standard architecture (ISA) bus, a peripheral component interconnect (PCI) bus, a universal serial bus (USB), or some other bus known in the art to provide similar functionality. Additional components coupled to control unit 350 through system bus 308 include the display device 310, the keyboard 312, the cursor control device 314, the network controller 316 and the I/O device(s) 318.

Display device 310 represents any device equipped to display electronic images and data as described herein. Display device 310 may be, for example, a cathode ray tube (CRT), liquid crystal display (LCD), or any other similarly equipped display device, screen, or monitor. In one embodiment, display device 310 may be equipped with a touch screen in which a touch-sensitive, transparent panel covers the screen of display device 310.

Keyboard 312 represents an alphanumeric input device coupled to control unit 350 to communicate information and command selections to processor 302. The Keyboard 312 can be a QWERTY keyboard, a key pad, or representations of such created on a touch screen.

Cursor control 314 represents a user input device equipped to communicate positional data as well as command selections to processor 302. Cursor control 314 may include a mouse, a trackball, a stylus, a pen, a touch screen, cursor direction keys, or other mechanisms to cause movement of a cursor.

Network controller 316 links control unit 350 to a network 104 that may include multiple processing systems and client devices 106a-n. The network 104 of processing systems may comprise a local area network (LAN), a wide area network (WAN) (e.g., the Internet), and/or any other interconnected data path across which multiple devices may communicate. The control unit 350 also has other conventional connections to other systems such as a network for distribution of files (media objects) using standard network protocols such as TCP/IP, http, https, and SMTP as will be understood to those skilled in the art.

One or more I/O devices 318 are coupled to the system bus 308. For example, the I/O device 318 includes an image scanner and document feeder for capturing an image of a document. The I/O device 318 also includes a printer for generating documents. The I/O device 318 may also include audio input/output device equipped to receive audio input via a microphone and transmit audio output via speakers. In one embodiment, audio device is a general purpose; audio add-in/expansion card designed for use within a general purpose computer system. Optionally, I/O audio device may contain one or more analog-to-digital or digital-to-analog converters, and/or one or more digital signal processors to facilitate audio processing.

It should be apparent to one skilled in the art that trade-in system 102 may include more or less components than those shown in FIG. 3 without departing from the spirit and scope of the present invention. For example, trade-in system 102 may include additional memory, such as, for example, a first or second level cache, or one or more application specific integrated circuits (ASICs). Similarly, additional components input/output devices 318 may be coupled to control unit 350 including, for example, an RFID tag reader, digital still or video cameras, or other devices that may or may not be equipped to capture and/or download electronic data to control unit 350. One or more components could also be eliminated such as cursor control 314.

FIG. 4 is a block diagram of one embodiment of the memory unit 304 for the trade-in system 102. The memory unit 304 for the trade-in system 102 preferably comprises: an operating system 402, a web browser 404, the pricing guide module 202, the affiliates module 204, the marketplace listing module 206, the trade-in website module 208, the transaction processing module 210, the inventory handling module 212, the database 214 and the marketplace manager 216. As noted above, the memory unit 304 stores instructions and/or data that may be executed by processor 302. The instructions and/or data may comprise code for performing any and/or all of the techniques described herein. These modules 402, 404, 202-216 are coupled by bus 308 to the processor 302 for communication and cooperation to provide the trade-in system 102. Those skilled in the art will recognized that while the present invention will now be described as modules or portions of a memory unit 304 of a computer system, the modules or portions may also be stored in other media such as permanent data storage device 306 and may be distributed across a network 104 having a plurality of different computers such as in a client/server environment.

The operating system 402 is preferably one of a conventional type such as, WINDOWS®, SOLARIS® or LINUX® based operating systems. Although not shown, the memory unit 304 may also include one or more application programs including, without limitation, word processing applications, electronic mail applications, financial applications, and web browser applications.

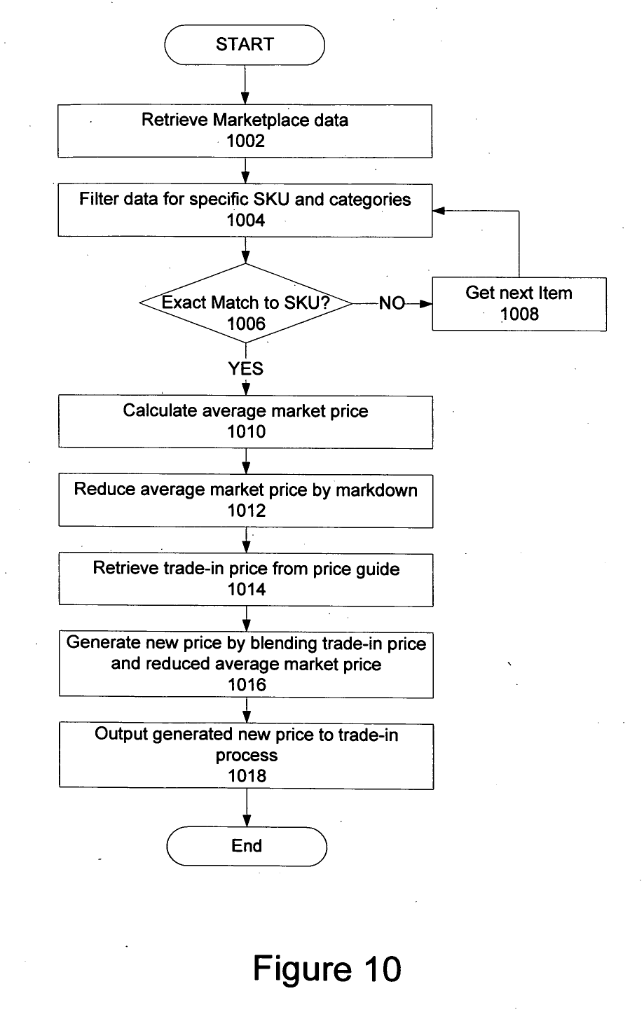

The function and operation of the pricing guide module 202, the affiliates module 204, the marketplace listing module 206, the trade-in website module 208, the transaction processing module 210, the inventory handling module 212, the database 214 and the marketplace manager 216 were described above so that description will not be repeated here. It should be noted that each of these modules 202-216 are coupled to the bus 308 for communication with each other and the processor 302. Such a coupling allows the modules to perform the methods described below with reference to FIGS. 5-11.

General Method

Referring now FIG. 5, the general method for performing a trade-in transaction in an online environment in accordance with the present invention will be described. At a general level, the method of the present invention has three major stages that can be separated in time. These three major stages include: 1) preparation of the website for acceptance of trade-ins; 2) user interaction with the trade-in system 102 to initiate the trade-in process; and 3) processing the trade-in item and listing it on a site for resale.

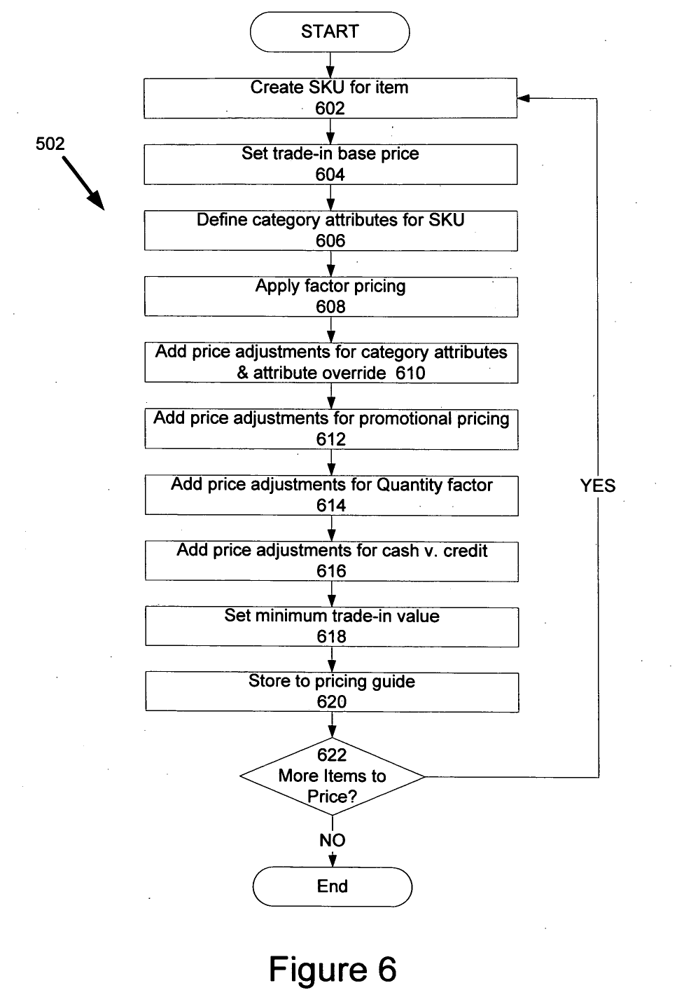

As shown in FIG. 5, the process begins by creating a pricing guide 502 for the trade-in item. This process must be performed for each item that is available for trade-in. This process is described in more detail below with reference to FIG. 6. The pricing guide preferably creates a record format for all data associated with a trade-in. The pricing guide includes price and other attributes that are necessary to describe the item being traded-in with particularity. Additionally, the pricing guide can include graphics or other information such as in an XML document that can be presented to the user when the user is identifying the item they are trading in. The pricing guide is preferably a database storing similar information for a variety of items.

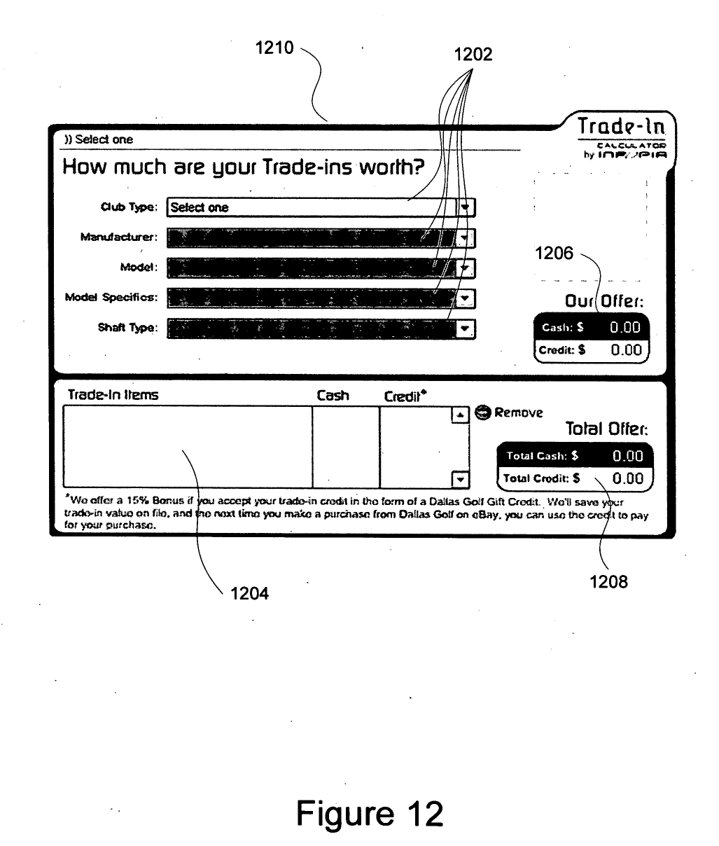

Once the pricing guide is created, the method of the present invention provides 504 access to the trade-in system 102 on at least one of a private website, an affiliate website or in an online marketplace. This is preferably done by creating hypertext links and associated graphics and data that are selectable by the user. Such hypertext links may be placed in a variety of locations such as a private website, an affiliate website or in an online marketplace. When selected by the user or clicked on, the user or their browser is re-directed to the trade-in system 102. As noted above, the trade-in system 102 includes a web server capable of providing information and executing transactions with the user. An exemplary web page 1200 for selecting the item to be traded in is shown in FIG. 12. While the exemplary web page is specific to trading in golf clubs, those skilled in the art will recognize that similar interfaces may be provided for inputting any type of information necessary to identify the item to be traded-in and its attributes.

Once the user begins to interact with the trade-in system, the trade-in process 506 is executed. The trade-in process and the user interaction with the system 102 is described in more detail below with reference to FIG. 7. Basically, the user inputs an item to-be traded-in using the interfaces of the present invention and shown below in FIGS. 12-18, inputs the attributes for the item being traded-in, and accepts a price for the trade-in item to complete this portion of trade-in process.

Next, the trade-in system 102 sends 508 the user the trade-in transaction information. This step can be accomplished in a variety of ways. First, if the user is purchasing other goods from a merchant, the information is sent to the user along with the other goods. For example, the transaction information and a label for sending the trade-in item back to the merchant (or other entity) are included with the other goods purchased by the user. Second, if it is a trade in without any other transaction, the trade-in system 102 can send an email to the user that includes the transaction information, and label that is printable by the user for sending the trade-in item back to the trade-in system 102. Third, trade-in system 102 can present a web page that includes the transaction information, and label that is printable by the user for sending the trade-in item back to the trade-in system 102. Those skilled in the art will recognize that these are only examples, and that there are a variety of other ways that the trade-in transaction information can be provided to the user.

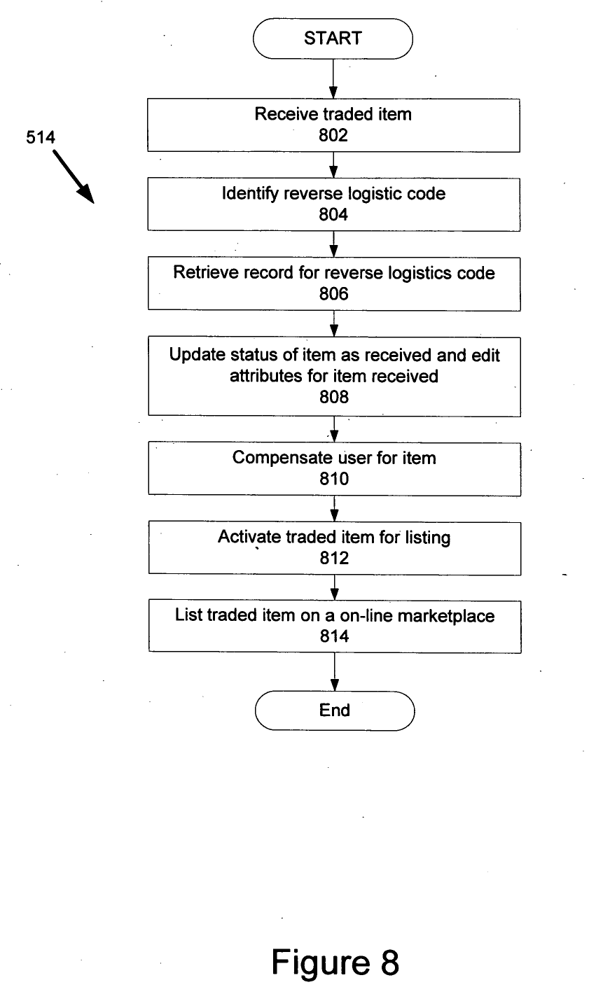

Once the user has completed step 506, the system 102 also adds 510 the transaction information regarding the trade-in item to the database 214. This is preferably performed by the marketplace manager 216. By adding the information regarding the trade-in to the database 214 eliminates the duplicate data entry when the trade-in item is send by the user. The user then sends 512 the trade-in item with the transaction information and it is received by the trade-in system 102. This could be simply a tracking code, SKU or other information provided on the shipping label, or it could be more detailed information. It need only be information sufficient to match the trade-in item to the record created in the database in step 510. Once the trade-in item is received by the trade-in system 102, it is processed 514 and added to the inventory available for sale by the trade-in system 102 or its affiliates. This processing 514 of the trade-in item is described in more detail below with reference to FIG. 8.

Pricing Guide Creation

Referring now to FIG. 6, the process for defining or creating 502 a pricing guide will be described in more detail. The process begins by creating 602 an identifying code or SKU for the trade-in item. A SKU is preferably used so that this identifying code can also be used by the marketplace manager 216 to identify the item when it is received and place in the inventory of the trade-in system 102. The SKU can be created using the marketplace manager interface, an inventory wizard or bulk upload from the database. Next, a base price for the trade-in item is set 604 by the merchant or trade-in system operator. This price is a starting point from which the final value for the trade-in item will be calculated. Then, the operator and the trade-in system 102 define 606 category attributes to be used in pricing the SKU or trade-in item. Many of the category attributes will affect the trade-in value of the item. Category attributes are custom defined data fields for the item. For example, these include but are not limited to title, description, picture URL, type, options list, age, condition, etc. Next, in step 608, factor pricing is applied to the trade-in value. Factor pricing allows data in file format to be input into the trade-in system 102 to adjust trade-in prices for a variety of factors including supply and demand for trade-in items. Then in step 610, the trade-in system 102 adjusts the price for category attributes and provides for product specific attribute pricing. Each of the category attributes includes default pricing based on the attributed selections made by the user during the trade-in process. This step also allows attributed pricing to be applied on the SKU level. In effect, this is an override of the category attribute pricing and is optional. Next, the promotion price adjustments are input 612 to the trade-in system. Promotional price adjustments are used by the trade-in system 102 to control pricing by category and offer more trade-in value for particular items. Then price adjustments for a quantity factor are input 614. Here, the system 102 can provide for differential pricing depending on the number of same items being traded in. Finally, price adjustments for cash versus credit are input to the trade-in system 102. In step 618, the system 102 sets the minimum trade-in value for item, and then in step 620, all the data for this item or SKU is stored to the pricing guide. In step 622, the method determines if there are additional items to be added to pricing guide. If not the method is complete and the pricing guide is created. If there are more items to be added to the pricing guide, the method returns to step 602, and repeats steps 604-622 for the next item. This process is repeated until all the available trade-in items have been added to the pricing guide.

Trade-In Process

Referring now to FIG. 7, the interaction 506 between the user and the trade-in system 102 will be described in more detail. The trade-in process begins once the user has selected to trade-in an item and transitions to a web page displayed by the trade-in system 102 as shown in FIG. 12. The user then specifies 702 and item for trade-in. This can be done in various ways such as selecting an item from a pull-down menu, selecting an item while browsing web pages of tradable items, or directly inputting the item. Then the system 102 displays 704 attribute categories for the item. While not required, if an item does have any attributes, the system 102 will specify the required attributes if any that must be specified for the trade-in item. The user inputs 706 those attributes; and based on the input from the user, the system 102 accesses the pricing guide and generates 708 a quote for a trade-in value or price. Next, the system 102 creates 710 a traded-in inventory item. This is preferably a record in the marketplace manager 216 including the reference information from the pricing guide regarding the item and attributes as well as a unique identification number that can be used to track the item from completion of the transaction, through inventory processing and re-listing in an online marketplace. Once the traded inventory item has been created, it is added 712 to a shopping cart or similar mechanism specific to the user. This is particularly advantageous because it can be combined with other merchant websites so that the trade-in can be directly seen as a credit against other purchases of new items form the merchant. Upon checkout, the transaction is completed and stored to the database as a pending item for which receipt of the item is open. In particular, during this step information about the individual who is trading-in the item including shipping address, credit card, and other information can be gathered and added to the system 102. Finally, the system 102 generates the transaction information and a reverse logistics code, and provides it to the user. In one embodiment, this is a prepaid shipping label that includes the SKU for the traded-in item. This is used by the user, to send the trade-in item back to the system 102.

Inventory Handling

Referring now to FIG. 8, the preferred method 514 for processing trade-in items will be described. The inventory handling process for a trade-in item begins with the receipt 802 of the traded item. Then the system 102 identifies 804 the reverse logistic code, and retrieves 806 the record in the database 214 corresponding to the reverse logistic code. This can be done in one embodiment by scanning a bar coded on the shipping label of the received item. An operator at the trade-in system 102 can then review the retrieved record and confirm that the item received matches the specifics of the record including item type, condition, etc. The record is then updated 808 to indicate that the trade-in item has been received, and any attributes for the item are modified based on the operator's physical inspection of the item. The system 102 then compensates 810 the user either by applying a credit to the user's credit card or other account, or by issuing and mailing a check to the user at the address input during the trade-in transaction. The system 102 can now activate 812 the traded item for listing. Since a record already exists, the system 102 can easily convert that record from a pending trade-in item, to a listing for an online market place or other selling point. This is particularly advantageous because the system 102 eliminates the multiple data entry steps of the prior art because the trade-in system 120 maintains a detailed record of the item that can be use for: 1) tracking of the pending trade-in item, 2) inventory updating and tracking once the item is received, and 3) listing of the item for resale. The inventory handling process completes by listing 814 the item on an online market place using the record originally created by the user at the very beginning 504 of the process.

Item Record Creation

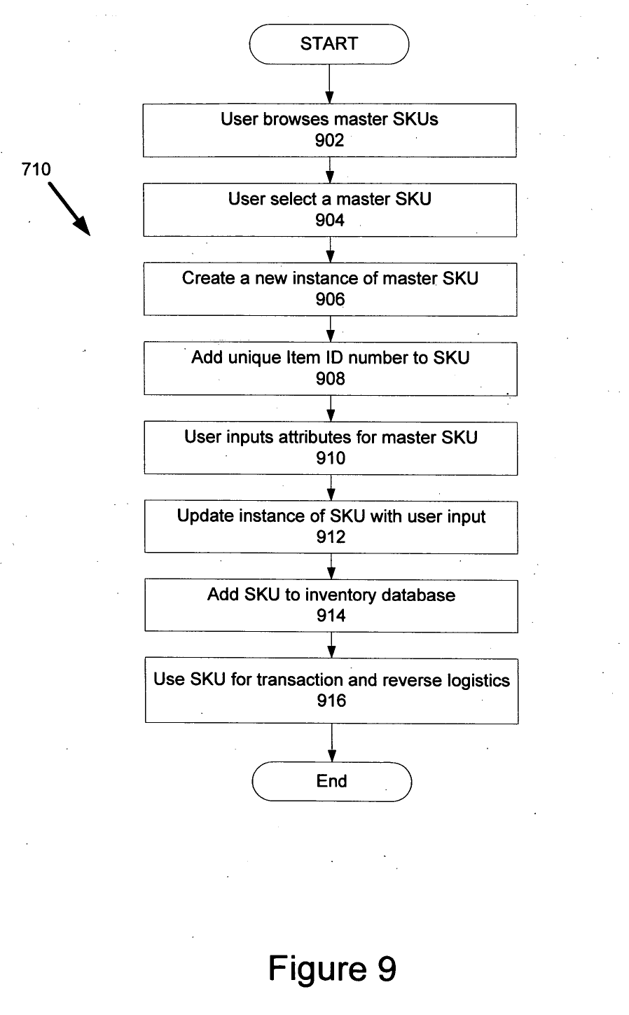

As has been just described above, a key advantage of the present invention is the ability to create trade-in item records that can be used in multiple phases of the trade-in process. A further advantage of the present invention is that there is little impact on the user since much of the information about an item is provided automatically by the system 102 using the pricing guide. Referring now to FIG. 9, one embodiment for item record or SKU creation 710 will be described. The process begins with the user browsing 902 master SKUs. The master SKUs are templates or partially completed records that include much of the information necessary to identify, process and re-list a trade-in item. Once the user selects 904 a master SKU, the system 102 creates 906 a new instance or record based on the information in the master SKU. Then the system 102 adds 908 a unique ID number to the new instance or record of the SKU. This unique ID number uniquely identifies this trade-in item from all others even if of the same type. It can also be used during different phases of the trade-in process to retrieve this record from the system 102. The user inputs 910 attributes into the system 102, and the system 102 updates 912 this new instance or record of the SKU with the user input. The new instance of the SKU is then added 914 to the inventory database 214. Then the new instance of the SKU is used 916 as has been described above to identify the transaction, printed on the return label for the trade-in item, and used to process the trade-in item when it is received.

Dynamic Pricing Guide

In an alternate embodiment, the system 102 can include a dynamic pricing guide. The pricing guide is dynamic in that the trade-in prices for items are modified periodically or immediately prior to a trade-in transaction to reflect the market price for that same item in an online marketplace. The process for generating dynamic prices begins by retrieving 1002 market place data. This can be done by downloading such information from the online market place such as eBay®, or any other source of historical transactions. Next, the system 102 filters the data for specific items or SKUs and categories. Since the market place data is likely to have all items sold, whereas the trade-in system 102 accepts only a smaller subset of those items, the data is first filtered 1004. This also makes the processing of the data more efficient and manageable. Next, the method determines 1006 whether there is an exact match between an SKU in the pricing guide and the SKU data provided by in step 1002. If not, the method gets the next item or SKU in the pricing guide in step 1008 and returns to step 1004. If there is an exact match between an SKU in the pricing guide and the SKU market data, the method calculates 1010 an average market price for all sales of that item. Then the average market price is reduced 1012 by a predetermined amount or markdown. This can either be a set dollar amount or a fixed percentage, but is preset by the operator of the trade-in system 102. Next, the method retrieves 1014 the trade-in price for the item from the pricing guide. Then a new price is generated 1016 by blending the trade-in price from the pricing guide and the reduced average market price. For example, this can be done by multiplying the trade-in price from the price guide and the reduced average market price each by 50% and summing them. Those skilled in the art will recognize a variety of modifications to the blending factors that may be used by the trade-in system 102. Finally, this new blended price is output to the trade-in process and used as the price paid to the user. As noted above, the frequency at which the prices are dynamically calculated can be set to be per transaction or any period from hourly, daily weekly etc.

Affiliates

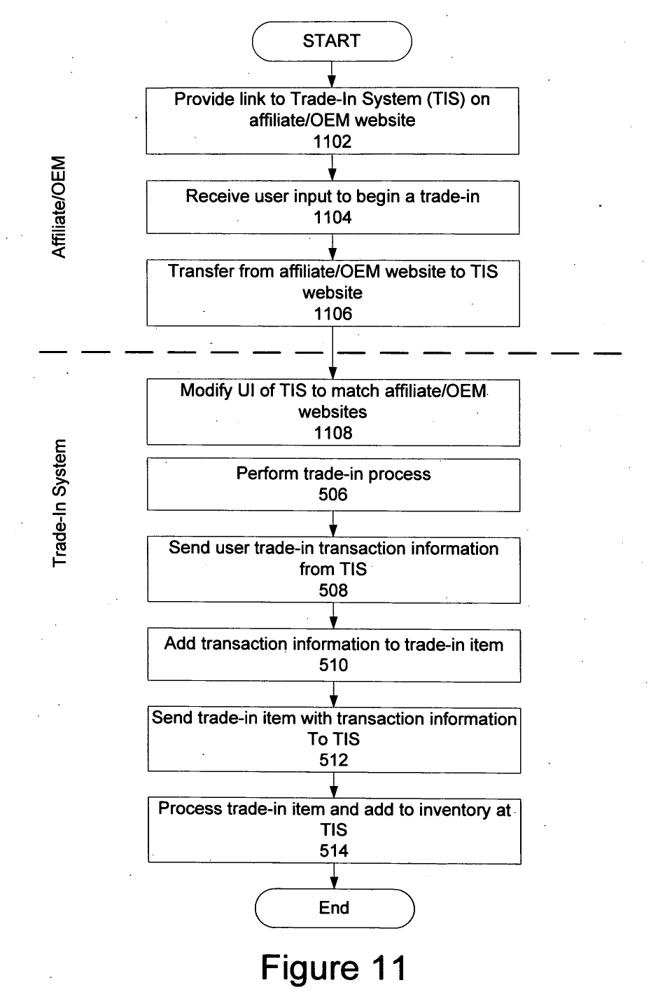

Another aspect of the present invention related to affiliates and OEMs is shown in FIG. 11. The present invention is particularly advantageous because the trade-in system 102 is operated independent from websites of affiliates or OEMs. Thus, the functionality of the trade-in system 102 of the present invention can be easily added to existing websites for online sales simply by adding references to the web pages of the trade-in system 102. A method for using the trade-in system with affiliates and OEMs is shown in FIG. 11. The method begins by providing 1102 links to the trade-in system 102 on the affiliate or OEM websites. Once these links are selected 1104 by a user visiting the affiliate or OEM website to begin a trade-in, the user is transferred 1106 from the affiliate or OEM website to the website of the trade-in system 102. For this embodiment, the user interfaces and website of the trade-in system 102 are modified 1108 in look and feel to match the websites of the affiliates or OEMs from which they are being transferred. Thus, to the user, it appears as if the trade-in program is offered and operated by the affiliates or OEMs. Once the user is transferred to the modified website of the trade-in system 102, processing continues in the same manner as has been described above with reference to FIG. 5 and the user proceeds through steps 506-514.

User Interfaces

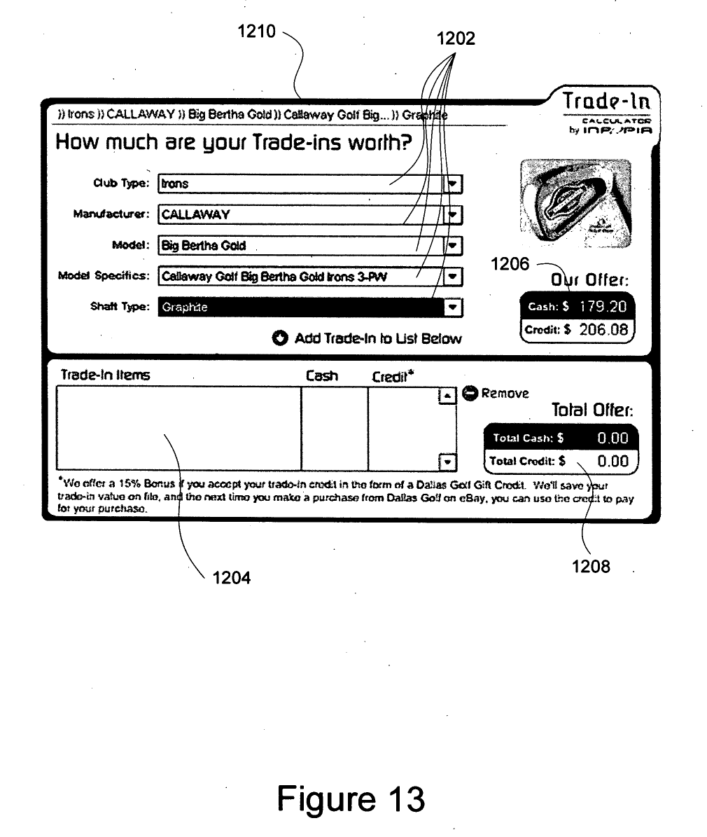

FIG. 12 is a graphical representation of an exemplary interface for beginning the trade-in process according to one embodiment of the present invention. FIG. 12 shows the interface 1210 including areas 1202 in which attributes of the item for trade can be input such as for step 504 above. For the particular item, the system 102 displays an offer price 1206 in terms of both cash and credit. The interface 1210 also has an area 1204 to indicate all items that have been selected for trade-in and a total offer 1208 of all trade-in items. FIG. 13 is shows an example of the interface 1210 after the user has input data reflecting the item to be trade and the trade-in price provided such as in steps 506 and 708 above. In particular, it should be noted that fields 1202 are complete with specific data, and the offer price is provided in field 1206.

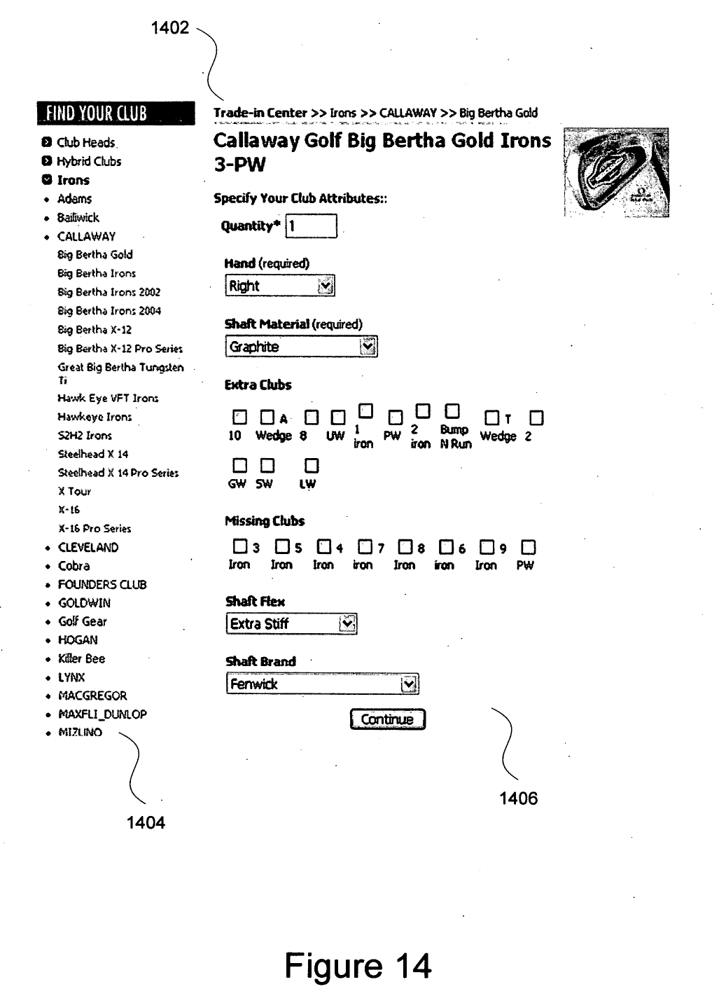

FIG. 14 is a graphical representation of another exemplary interface 1402 for specifying additional data information about an item to be traded-in according to the present invention. For example, this interface 1402 can be use for steps 506 and 706 described above. This interface 1402 includes an area 1404 providing a menu for easy access to other items that the trade-in system 102 will accept. This interface 1402 also provides a mechanism for the user to input additional data beyond that provided with the initial interface 1210. Specifically, this interface provides a large area 1406 in which all the other attributed about the item may be input. For ease of use, the interface 1402 advantageously provides pull down menus, radio buttons and various other interface devices for easily identifying the trade-in item.

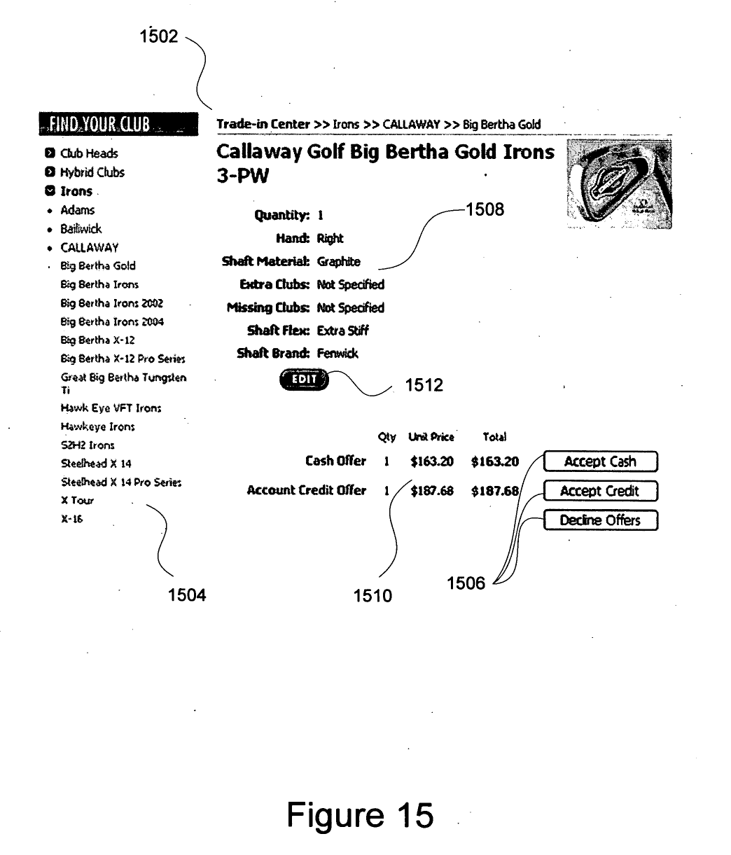

FIG. 15 is a graphical representation of an exemplary interface 1502 for accepting a trade-in offer from the system 102 according to the present invention. For example, this interface 1502 can be used in step 708 described above to receive confirmation from the user of the trade-in. The interface 1502 includes: 1) an area 1504 providing a menu for easy access to other items that the trade-in system 102 will accept; 2) an area 1508 presenting information confirming the identification of the trade-in item, and 3) buttons 1506 to accept or decline the trade-in offer. The interface 1502 also provides an area 1510 to display the offer prices and a button 1512 to edit the description of the trade-in item.

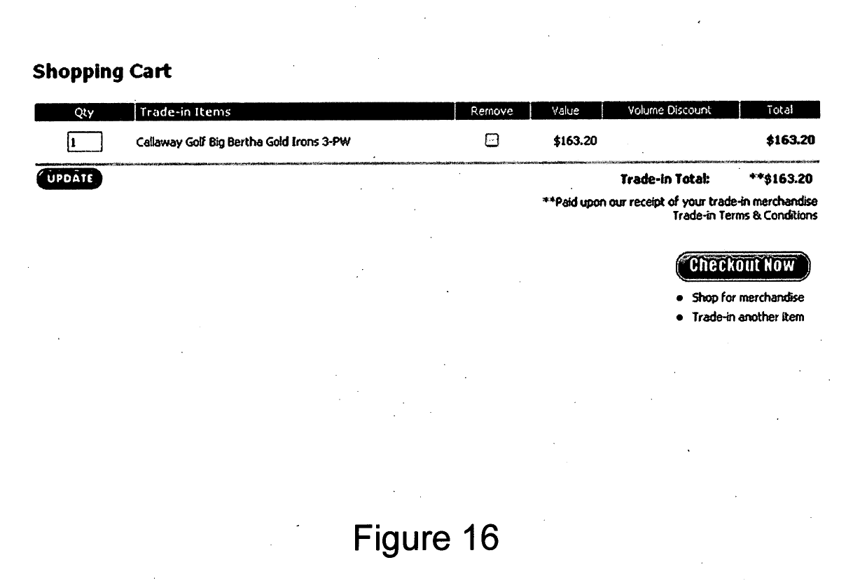

FIG. 16 is a graphical representation of an exemplary shopping cart interface generated by the trade-in system 102 of the present invention. This interface can be used to receive input and provide data to the user in-step 712 noted above.

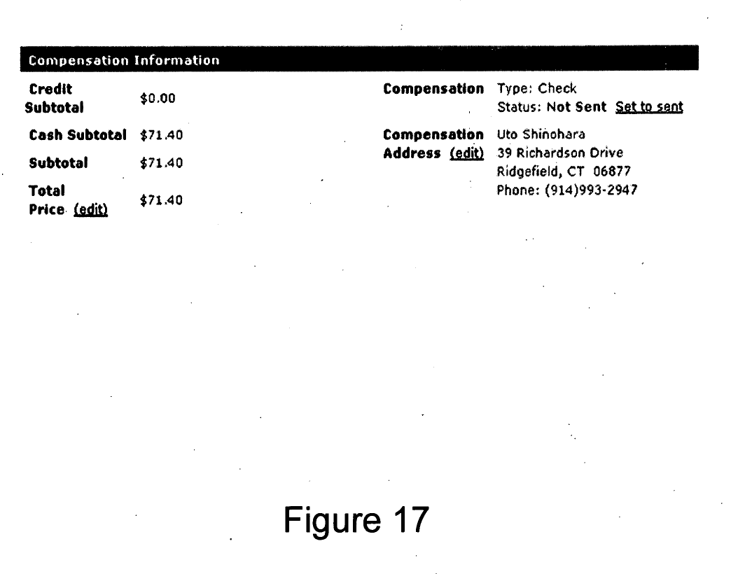

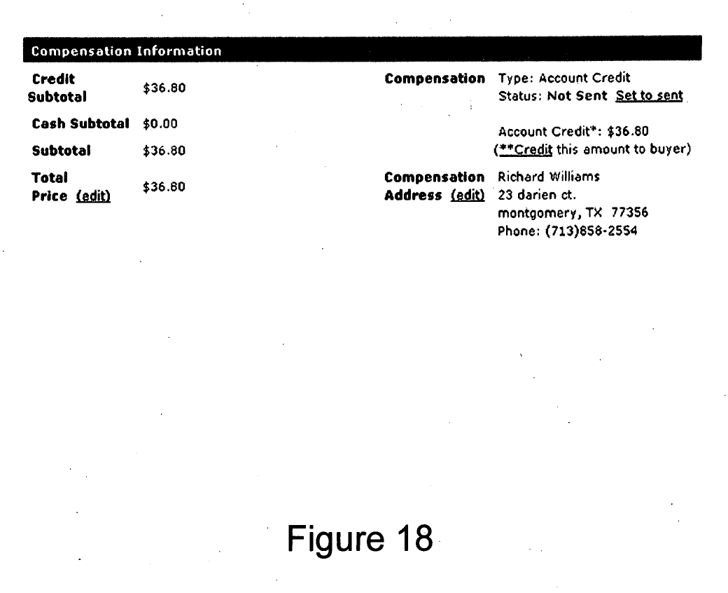

FIGS. 17 and 18 are graphical representations of an exemplary interface generated by the trade-in system 102 for providing compensation information to a user about a trade-in such as in step 810 noted above. FIG. 17 is for cash compensation while FIG. 18 is for credit compensation. These interfaces can be accessible the user, or used by operators in processing the trade-in item once received.

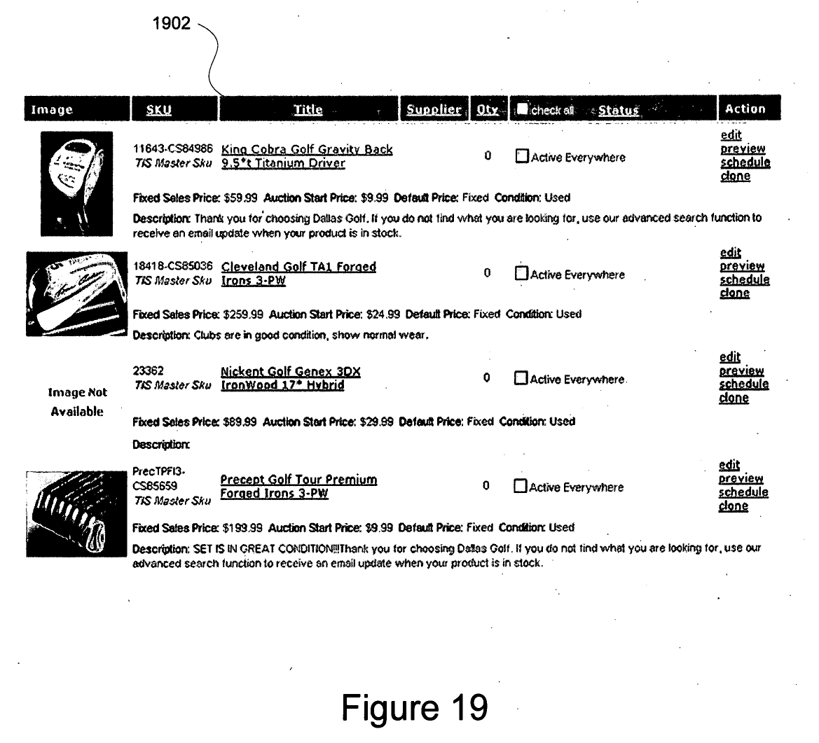

FIG. 19 is a representation of an exemplary interface 1902 generated by the trade-in system for providing master SKUs to a user about trade-in items according to one embodiment of the present invention. As can be seen, the interface 1902 provides information about item that is acceptable for trade-in and provides much of the information so that user merely needs to make a selection and provide some information particular to the item being traded such as condition. The interface 1902 can be used in step 902 described above.

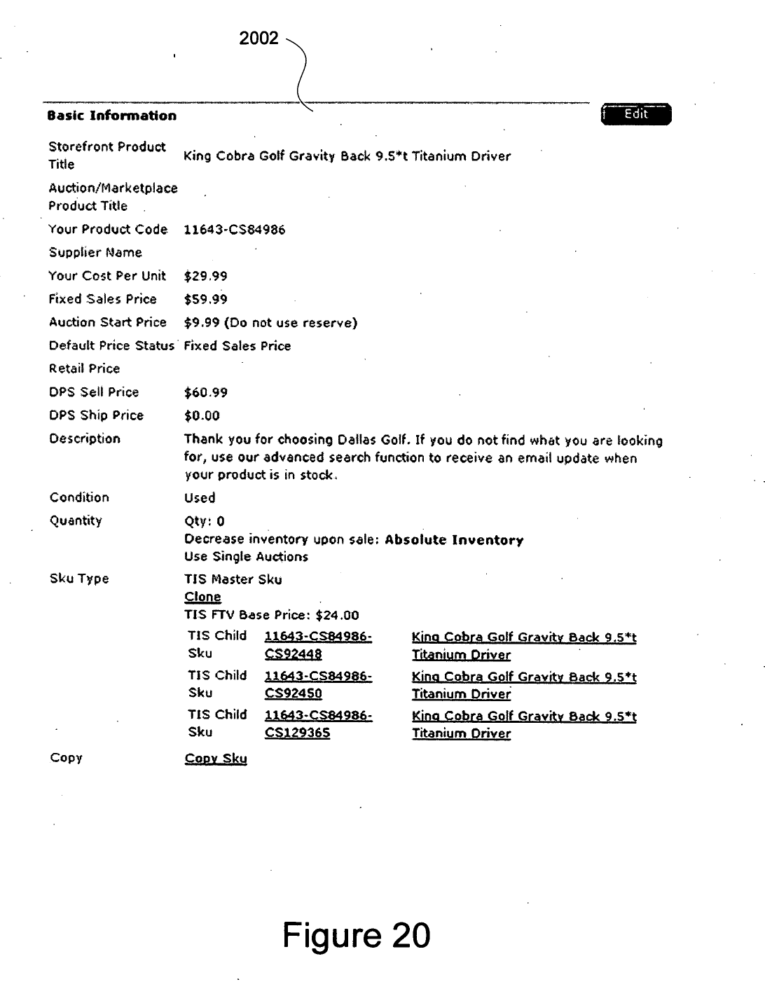

FIG. 20 is a representation of an exemplary interface 2002 generated by the trade-in system 102 for providing SKU data to a user about a trade-in item. This interface 2002 is for users to generate new SKU for traded items such as in step 906 described above.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Of course, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for selling a trade-in item using an online trade-in system, the method comprising the steps of:
providing a user with access to the trade-in system via a network;
initiating a trade-in process to generate a code and transaction information identifying the trade-in item;
sending the code and transaction information to the user;
receiving the trade-in item and the code at the trade-in system; and
processing the trade-in item and adding it to inventory of the trade-in system.

2. The method of claim 1 further comprising the step of adding a record including the code and transaction information to a marketplace manager.

3. The method of claim 1, wherein the method further comprises creating a pricing guide.

4. The method of claim 3, wherein the step of creating the pricing guide further comprises the steps of:
creating a master record for an item acceptable for trade-in;
setting a base price for the item acceptable for trade-in;
defining a category attributed for the item acceptable for trade-in; and
storing the master record, the base price and the category attribute to the pricing guide.

5. The method of claim 4, further comprising the step of adding a price adjustment, and wherein the step of storing stores the price adjustment in the pricing guide.

6. The method of claim 5, wherein the price adjustment is one from the group of: a factor pricing adjustment, a category attribute adjustment, an attribute override adjustment, a promotional pricing adjustment, a quantity factor adjustment, and a cash versus credit adjustment.

7. The method of claim 4, further comprising the steps of:
setting a minimum trade in-value for the item acceptable for trade-in, and repeating the steps of creating, setting, defining and storing for a plurality of additional items.

8. The method of claim 3, wherein the pricing guide is dynamic.

9. The method of claim 8, wherein the step of creating the pricing guide further comprises:
retrieving market place data;
filtering the marketplace date for specific record and category attributes;
calculating an average market price
reducing the average market price by a markdown;
retrieving the trade-in price for the record from the pricing guide;
generating a new price by blending the retrieved trade-in price with the reduced average market price; and
providing the new price as the trade-in price to the trade-in process.

10. The method of claim 1, wherein:
the step of providing the user with access to the trade-in system via the network is performed by providing a link to the trade-in system on a website of a third party;
the method further comprises:
receiving user input to begin a trade-in;
transferring the user from the third party website to a website of the trade-in system; and
modifying interfaces provided by the website of the trade-in system to match an appearance of the website of the third party.

11. The method of claim 1, wherein the step of initiating the trade-in process further comprises:
receiving input from the user specifying the item for trade-in;
displaying an attribute category for the item;
receiving input from the user specifying attributes;
generating a price quote for the trade-in item by accessing a pricing guide;
creating a record including the code and transaction information; and
storing the record in a marketplace manager.

12. The method of claim 11, further comprising,
adding the record to a shopping cart; and
receiving confirmation of the trade-in transaction from the user before performing the creating and storing steps.

13. The method of claim 11, further comprising providing a plurality of master records for the user to browse, and wherein the step of receiving input from the user specifying the item for trade-in comprises selection of one of the plurality of master records.

14. The method of claim 11, wherein the step of creating a record including the code and transaction information, further comprises:
creating a new instance of a master record;
adding a unique item identifier to the new instance of the master record;
adding user inputs on attributes to the new instance of the master record; and
and wherein the new instance is stored in the marketplace manager by storing it in an inventory database.

15. The method of claim 1, wherein the step of processing the trade-in item and adding it to inventory of the trade-in system, further comprises the steps of,
identifying the code on the received trade-in item;
retrieving the record corresponding to the code;
updating status of the trade-in item as received;
compensate the user for the trade-in item;
activate the trade-in item for listing; and
list the trade-in item on an online marketplace using the record.

16. An online trade-in system comprising:
a pricing guide module for creating a list of tradeable items including a price for a trade-in item, the pricing guide module having an input and an output, the input coupled to receive data;
a marketplace listing module having an input and an output for presenting a tradeable item and related information including a price to the user, the input of the marketplace listing module coupled to the pricing guide module for retrieving the price;
a transaction processing module having an input and an output for accepting input from the user and completing a trade-in transaction, the input of the transaction processing module coupled to receive input from the user, the marketplace listing module, and the pricing guide; and
an inventory handling module having an input and an output for processing the trade-in item, the inventory handling module coupled for communication with the transaction processing module, the inventory handling module automatically listing the trade-in item for sale in an online marketplace.

17. The system of claim 16 further comprising a marketplace manager coupled to and controlling the pricing guide module, the marketplace listing module, the transaction processing module, and the inventory handling module, the marketplace manager facilitating and managing the purchase of trade-in items and re-listing them on an online marketplace.

18. The system of claim 16 further comprising an affiliates module having and input and output for redirecting potential users from a website of a third party to the website of the trade-in system, the input and output of the affiliates module coupled for communication with the user and the trade-in system.

19. The system of claim 16 wherein the pricing guide module includes an item identification number, a description, and base trade-in price for each tradable item.

20. The system of claim 19 wherein the pricing guide module includes a specific attribute that affects the value of the item, and a price adjustment for the specific attribute.

21. The system of claim 16 wherein the marketplace listing module further comprises a trade-in website module, the trade-in website module providing customer facing web pages that allows users to browse equipment eligible for trade, and provide additional information on the item for trade-in.

22. The system of claim 16 wherein the transaction processing module also presents interfaces to specify attributes of goods for trade-in and pricing and creates an inventory record.

23. The system of claim 16 further comprising a database for storing the pricing guide, data about specific goods, transactions and other information, the database coupled to communicate with the pricing guide module, the marketplace listing module, the transaction processing module, and the inventory handling module.

24. The system of-claim 16 wherein the inventory handling module also updates an inventory record indicating the trade-in item has been received, verify or correct the attributes of the trade-in item and generates a payment to the user.
